(19) United States
(12) Patent Application Publication
(10) Pub. No.: US 2015/0058500 A1
(43) Pub. Date: Feb. 26, 2015

(54) COMMUNICATION APPARATUS AND RELATED SIGNAL RECEIVING APPARATUS

(71) Applicant: Realtek Semiconductor Corp., Hsinchu (TW)

(72) Inventors: Chun-Chu Chang, Taichung City (TW); Chia-Yi Liu, Changhua County (TW); Kuang-Yu Yen, Taichung City (TW); Jia-Ching Shen, Taipei City (TW)

(21) Appl. No.: 14/464,720

(22) Filed: Aug. 21, 2014

(30) Foreign Application Priority Data
Aug. 23, 2013 (TW) 102130291

(51) Int. Cl. H04W 88/08; G06F 13/10; H04W 74/00; G06F 13/38

(52) U.S. Cl. CPC H04W 88/08; G06F 13/385; G06F 13/102; H04W 74/00
USPC 710/14

(57) ABSTRACT

A communication apparatus includes a host, a signal receiving apparatus arranged to receive a wireless signal, and a connecting device coupled between the host and the signal receiving apparatus. The connecting device is arranged to transmit a transmission signal between the host and the signal receiving apparatus. The signal receiving apparatus refers to the state of the received wireless signal to control the connecting device to selectively enter a second operation mode from a first operation mode to reduce the interference upon the wireless signal.

### BACKGROUND OF THE INVENTION

1. Field of the Invention

The present invention relates to a wireless communication apparatus and associated signal receiving apparatus, more particularly, to a wireless communication apparatus and associated signal receiving apparatus capable of improving the signal reception capability.

2. Description of the Prior Art

With the advance of the wireless communication specification, the transmission rate of the wireless communication physical layer is about to reach the level of Giga bps. For example, according to the 802.11ac specification defined by the institute of electrical and electronics engineers (IEEE), the data transmission quantity reaches one giga bps. In the present communication systems, the universal serial bus (USB) 2.0 specification with a 480 M bps transmission rate is still commonly used as the wireless communication network controller interface. Since the USB2.0 specification is incapable of supporting the high data transmission rate, the USB3.0 specification with a 5 Gbps transmission rate is more and more popular. However, as the operation clock of the data bus of the USB3.0 specification is 2.5 GHz, the signal radiation and signal coupling introduced by the 2.5 GHz clock may physically cause huge interference to the 2.4 GHz band of the wireless network when the USB3.0 interface is used along with a wireless communication apparatus, which results in a shorter signal receiving distance for the wireless communication apparatus. In other words, when a USB3.0 interface and a wireless communication apparatus operate at the same time, the wireless communication apparatus can not correctly receive the packets transmitted over a longer distance. Hence, how to reduce the interference between a USB3.0 interface and a wireless communication apparatus to improve the signal receiving capability has become an issue to be solved in the wireless communication field.

### SUMMARY OF THE INVENTION

In view of above, an embodiment of the present invention provides a wireless communication apparatus and an associated signal receiving apparatus capable of improving the signal reception capability.

According to an embodiment of the present invention, a communication apparatus is provided. The communication apparatus includes a host, a signal receiving apparatus arranged to receive a wireless signal, and a connecting device coupled between the host and the signal receiving apparatus. The connecting device is arranged to transmit a transmission signal between the host and the signal receiving apparatus. The signal receiving apparatus makes the connecting device selectively enter a second operation mode from a first operation mode according to the state of receiving the wireless signal, so as to reduce the interference upon the wireless signal.

According to another embodiment of the present invention, a signal receiving apparatus is provided. The signal receiving apparatus is capable of performing data transmission with a host through a connecting device. The signal receiving apparatus includes a connection controller, a wireless transceiver and a memory device. The connection controller is coupled to the connecting device. The wireless transceiver is coupled to the connecting device controller and an antenna, for receiving the wireless signal from the antenna. The memory device is for storing data corresponding to the wireless signal. The signal receiving apparatus controls the connecting device to selectively enter a second operation mode from a first operation mode according to a transmission state of the wireless signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a wireless communication apparatus according to an embodiment of the present invention.

FIG. 2 is a flowchart showing a first control method for controlling a status of a wireless communication apparatus according to an embodiment of the present invention.

FIG. 3 is a flowchart showing a second control method for controlling a status of a wireless communication apparatus according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one apparatus is coupled to another apparatus, that connection may be through a direct electrical connection, or through an indirect electrical connection via other apparatus and connections.

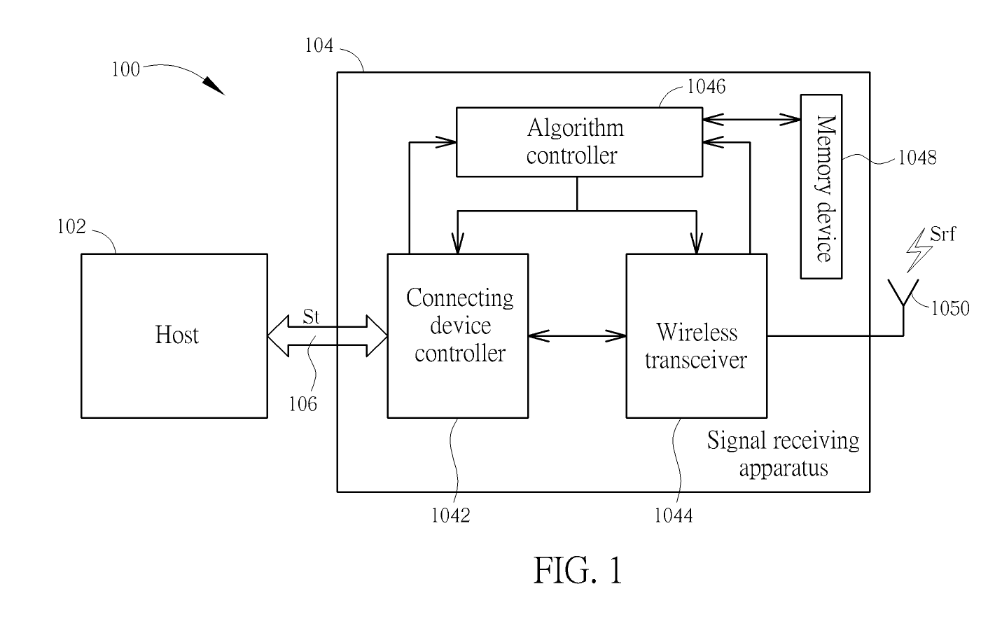

Please refer to FIG. 1, which shows a wireless communication apparatus 100 according to an embodiment of the present invention. As shown in FIG. 1, the wireless communication apparatus 100 has a host 102, a signal receiving apparatus 104 and a connecting device 106. In this embodiment, the host 102 can be viewed as a host complying with the USB3.0 specification. The connecting device 106 can be viewed as a transmission line complying with the USB3.0 specification. The signal receiving apparatus 104 can be viewed as a receiving apparatus included in a wireless signal transceiving apparatus complying with the 802.11ac communication specification defined by IEEE. Please notice that, the present invention is not limited to the above embodiment. One skilled in the art can also apply the spirit of the present invention to apparatuses complying with other signal transmission specifications. In this embodiment, the signal receiving apparatus 104 can be used to receive a wireless signal Srf, where a carrier frequency of the wireless signal Srf is about 2.4 GHz. The connecting device 106 is coupled between the host 102 and the signal receiving apparatus 104, and used for transmitting a transmission signal St between the host 102 and the signal receiving apparatus 104. The data transmission rate of the transmission signal St is about 5 Gbps. When the signal receiving apparatus 104 receives the wireless signal Srf, the signal receiving apparatus 104 refers to its transmission state of receiving the received wireless signal Srf to control the connecting device 106 to selectively enter a second operation mode from a first operation mode for reducing the interference upon the wireless signal Srf, where the first operation mode is different from the second operation mode. More specifically, the power of the transmission signal St transmitted by the connecting device 106 under the second operation mode is lower than the power of the transmission signal St transmitted by the connecting device 106 under the first operation mode.

The signal receiving apparatus 104 has a connecting device controller 1042, a wireless transceiver 1044, an algorithm controller 1046, a memory device 1048 and an antenna 1050. The connecting device controller 1042 is coupled to the connecting device 106. The wireless transceiver 1044 is coupled to the connecting device controller 1042 and the antenna 1050, and used for receiving the wireless signal Srf from the antenna 1050. The algorithm controller 1046 is coupled to the connecting device controller 1042 and the wireless transceiver 1044. The memory device 1048 is coupled to the algorithm controller 1046, and used for storing data corresponding to the wireless signal Srf. Further, the algorithm controller 1046 is used for selectively controlling the connecting device to enter the second operation mode from the first connection mode. Please notice that, in an embodiment of the present invention, the algorithm controller 1046 may be implemented with hardware or firmware built in the signal receiving apparatus 104, and used for determining an operation mode of the connecting device 106 according to a transceiving state of the wireless signal Srf.

According to an embodiment of the present invention, the first operation mode of the connecting device 106 is compatible with the U0 connecting mode defined by the USB3.0 specification, and the second operation mode is compatible with the U1 or U2 connecting mode defined by the USB3.0 specification. More specifically, when the connecting device 106 is in the U0 connecting mode, the connecting device 106 stays at the active state. When the connecting device 106 is in the U1 connecting mode, the connecting device 106 stays at the fast exit idle state. When the connecting device 106 is in the U2 connecting mode, the connecting device 106 stays at the slow exit idle state. More specifically, when being at the fast exit idle state, the connecting device 106 enters a standby/sleep mode, while the clock of the equipment, such as the host 102 or the connecting device controller 1042, remains at an operation state. And when being at the slow exit idle state, the clocks of the connecting device 106 and the equipment are turned off at the same time. As a result, the connecting device 106 needs more time to re-build the connection and transmit data. Please notice that, besides the aforementioned first and second operation modes, the connecting device 106 may also be controlled to enter a third operation mode, such as the U3 connecting mode defined by the USB30.0 specification. When the connecting device 106 is in the U3 connecting mode, the connecting device 106 stays at a suspend state.

On the other hand, the signal receiving apparatus 104 is controlled to operate in one of the first, the second and the third signal receiving modes. When the signal receiving apparatus 104 is operated in the first signal receiving mode, the wireless transceiver 1044 in the signal receiving apparatus 104 can provide power for outputting signals and receiving signals transmitted over a longest distance. When the signal receiving apparatus 104 is operated in the second signal receiving mode, the wireless transceiver 1044 in the signal receiving apparatus 104 can provide power for outputting signals, and receiving wireless signals transmitted over a shorter distance or wireless signals having higher power. And when the signal receiving apparatus 104 is operated in the third signal receiving mode, the wireless transceiver 1044 in the signal receiving apparatus 104 will be turned off. At this moment, the signal receiving apparatus 104 does not output signals and does not receive wireless signals. Hence, when the signal receiving apparatus 104 is operated in the first signal receiving mode, the signal receiving apparatus 104 performs the transmission and reception of the wireless signals in a longest distance. When the signal receiving apparatus 104 is operated in the second signal receiving mode, the signal receiving apparatus 104 performs the transmission and reception of the wireless signals in a shorter distance or the wireless signals having higher power. More specifically, the power of the wireless signal received by the signal receiving apparatus 104 under the first signal receiving mode is lower than the power of the wireless signal received by the signal receiving apparatus 104 under the second signal receiving mode. Hence, with regard to the same transmitting end, the signal receiving distance of the signal receiving apparatus 104 is longer when the signal receiving apparatus 104 is operated in the first signal receiving mode, while the signal receiving distance of the signal receiving apparatus 104 is shorter when the signal receiving apparatus 104 is operated in the second signal receiving mode.

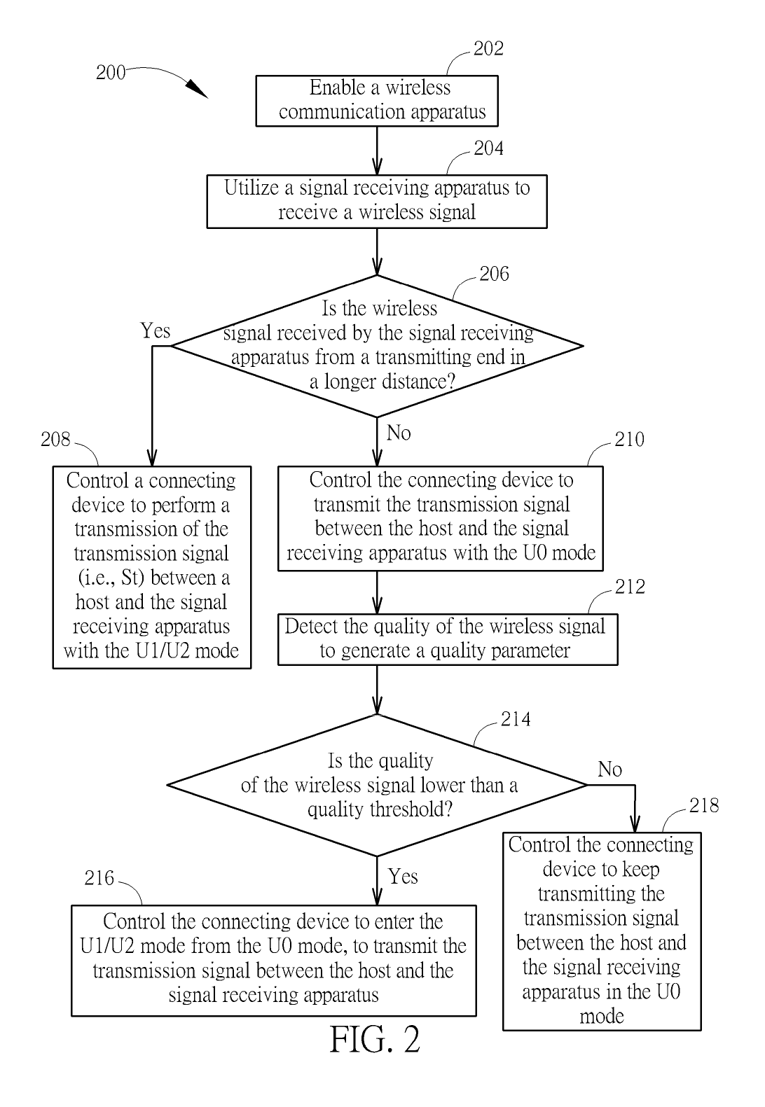

Please refer to FIG. 2, which is a flowchart showing a first control method 200 for controlling an operation status of a wireless communication apparatus 100 according to an embodiment of the present invention. Provided that the result is substantially the same, the steps are not required to be executed in the exact order shown in FIG. 2. The exemplary first control method 200 may be employed by the wireless communication apparatus 100 shown in FIG. 1, and can be briefly summarized using following steps.

Step 202: Enable the wireless communication apparatus 100.

Step 204: Utilize the signal receiving apparatus 104 to receive the wireless signal Srf.

Step 206: Determine whether the wireless signal Srf received by the signal receiving apparatus 104 is from a transmitting end in a longer distance. If yes, go to step 208; otherwise, go to step 210.

Step 208: Control the connecting device 106 to perform the transmission of the transmission signal (i.e., St) between the host 102 and the signal receiving apparatus 104 with the U1/U2 mode.

Step 210: Control the connecting device 106 to transmit the transmission signal (i.e., St) between the host 102 and the signal receiving apparatus 104 with the U0 mode.

Step 212: Detect the quality of the wireless signal Srf to generate a quality parameter Sd.

Step 214: Determine whether the quality of the wireless signal Srf is lower than a quality threshold according to the quality parameter Sd. If yes, go to step 216; otherwise, go to step 218.

Step 216: Control the connecting device 106 to enter the U1/U2 mode from the U0 mode, to transmit the transmission signal (i.e., St) between the host 102 and the signal receiving apparatus 104.

Step 218: Control the connecting device 106 to keep transmitting the transmission signal St between the host 102 and the signal receiving apparatus 104 based on the U0 mode.

In this embodiment, the wireless communication apparatus 100 initially receives the wireless signal Srf through the signal receiving apparatus 104, and then selectively adjusts the connecting mode of the connecting device 106 according to the quality of the wireless signal Srf. When the wireless communication apparatus 100 is operating, the first control method 200 of the present invention adjusts the connecting mode of the connecting device 106 according to the quality of the wireless signal Srf, so as to prevent the operation clock of the connecting device 106 from influencing the signal reception capability of the signal receiving apparatus 104 for the wireless signal Srf. In step 208, when the wireless signal Srf received by the signal receiving apparatus 104 comes from a transmitting end in a longer distance (i.e., the first signal receiving mode), it means that the power of the wireless signal Srf to be received is lower. Hence, the connecting device 106 cannot transmit the transmission signal St with U0 mode. This is because that, when the connecting device 106 transmits the transmission signal St with U0 mode, the operation clock of the connecting device 106 would have a maximum power, thus introducing stronger signal radiation and signal coupling to interfere with the signal reception of the wireless signal Srf that is performed by the signal receiving apparatus 104. Therefore, the host 102 or the algorithm controller 1046 adjusts the operation mode of the connecting device 106 to be the U1/U2 mode. Since the U1/U2 mode is a low power consumption mode defined by the USB3.0 specification, the connecting device 106 does not generate signal radiation and signal coupling to interfere with the signal reception of the wireless signal Srf that is performed by the signal receiving apparatus 104.

In step 210, when the wireless signal Srf received by the signal receiving apparatus 104 comes from a transmitting end in a shorter distance (i.e., the second signal receiving mode), it means that the power of the received wireless signal Srf is higher. Hence, the connecting device 106 will initially transmit the transmission signal St in the U0 mode. Besides, in step 212, the algorithm controller 1046 generates the quality parameter Sd by detecting the quality of the wireless signal Srf. The quality parameter Sd is for determining whether the quality of the wireless signal Srf is lower than a quality threshold, that is, determining whether the quality of the wireless signal Srf is interfered with the signal radiation and signal coupling resulting from the operation clock of the connecting device 106. When the algorithm controller 1046 determines that the quality of the wireless signal Srf is lower than a quality threshold, the host 102 or the algorithm controller 1046 controls the connecting device 106 to enter the U1/U2 mode from the U0 mode (step 216). When the algorithm controller 1046 determines that the quality of the wireless signal Srf is not interfered with the signal radiation and signal coupling resulting from the operation clock of the connecting device 106, the host 102 or the algorithm controller 1046 controls the connecting device 106 to keep staying at the U0 mode to transmit the transmission signal St between the host 102 and the signal receiving apparatus 104 (step 218). Please notice that, in steps 208 and 216, the host 102 or the algorithm controller 1046 may control the connecting device 106 to enter a U3 mode to suspend the transmission between the host 102 and the signal receiving apparatus 104. Further, in step 204, when the signal receiving apparatus 104 is arranged to receive the wireless signal Srf, the host 102 or the algorithm controller 1046 of the present invention may directly adjust the operation mode of the connecting device 106 to be the U1/U2/U3 mode, thus skipping the step of determining the quality of the wireless signal Srf. Moreover, in step 210, when the received wireless signal Srf comes from a transmitting end in a shorter distance, the host 102 or the algorithm controller 1046 of the present invention may directly adjust the operation mode of the connecting device 106 to be the U0 mode, thus skipping the step of determining the quality of the wireless signal Srf.

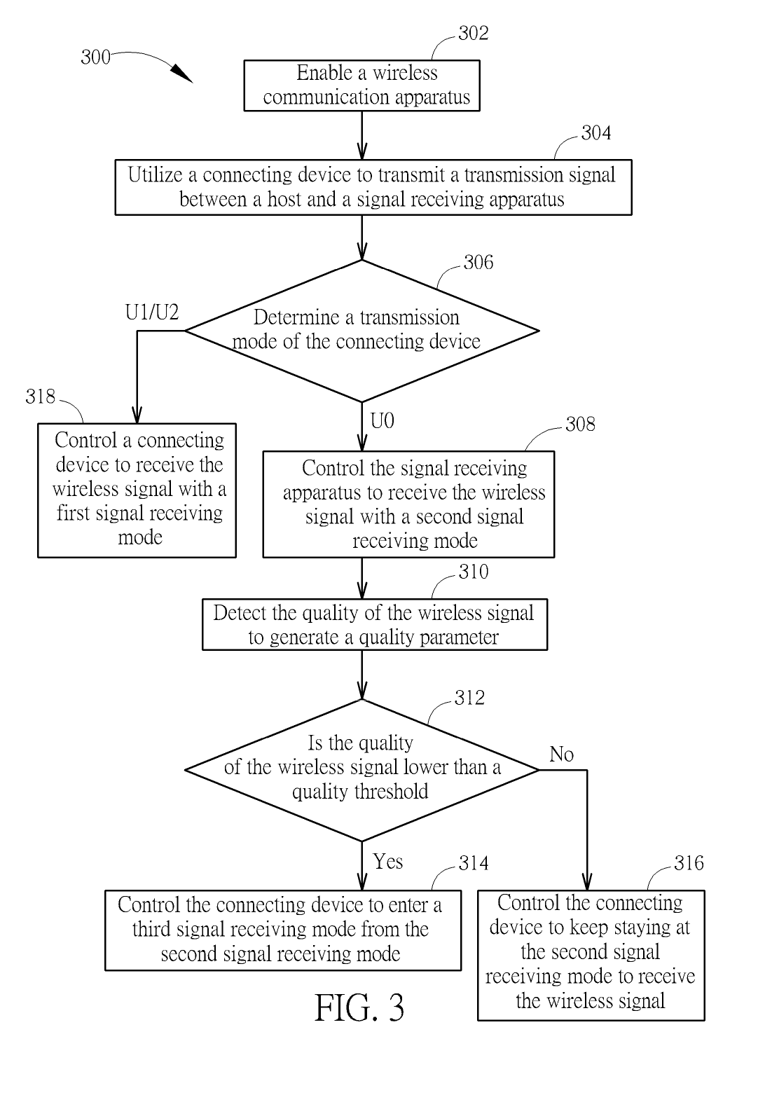

Please refer to FIG. 3, which is a flowchart showing a second control method 300 for controlling an operation status of a wireless communication apparatus 100 according to an embodiment of the present invention. Provided that the result is substantially the same, the steps are not required to be executed in the exact order shown in FIG. 3. The exemplary second control method 300 may be employed by the wireless communication apparatus 100 shown in FIG. 1, and can be briefly summarized using following steps.

Step 302: Enable the wireless communication apparatus 100.

Step 304: Utilize the connecting device 106 to transmit the transmission signal St between the host 102 and the signal receiving apparatus 104.

Step 306: If the connecting device 106 transmits the transmission signal St between the host 102 and the signal receiving apparatus 104 in the U0 mode, go to step 308; if the connecting device 106 transmits the transmission signal St between the host 102 and the signal receiving apparatus 104 in the U1/U2 mode, go to step 318;

Step 308: Control the signal receiving apparatus 104 to receive the wireless signal Srf with the second signal receiving mode.

Step 310: Detect the quality of the wireless signal Srf to generate a quality parameter Sd.

Step 312: Determine whether the quality of the wireless signal Srf is lower than a quality threshold according to the quality parameter Sd. If yes, go to step 314; otherwise, go to step 316.

Step 314: Control the connecting device 104 to enter the third signal receiving mode from the second signal receiving mode.

Step 316: Control the connecting device 104 to keep staying at the second signal receiving mode to receive the wireless signal Srf.

Step 318: Control the connecting device 104 to receive the wireless signal Srf with the first signal receiving mode.

In this embodiment, the wireless communication apparatus 100 initially utilizes the connecting device 106 to transmit the transmission signal St between the host 102 and the signal receiving apparatus 104, and then selectively adjusts the connecting mode of the signal receiving apparatus 104 based on the quality of the wireless signal Srf. Similarly, when the wireless communication apparatus 100 is in operation, the second control method 300 of the present invention adjusts the operation mode of the signal receiving apparatus 104 according to the quality of the wireless signal Srf, so as to prevent the operation clock of the connecting device 106 from influencing the signal reception capability of the signal receiving apparatus 104 for the wireless signal Srf. In step 308, when the connecting device 106 transmits the transmission signal between the host 102 and the signal receiving apparatus 104 by using the U0 mode, the algorithm controller 1046 controls the signal receiving apparatus 104 to receive the wireless signal Srf with the second signal receiving mode first. That is, when the connecting device 106 is in the U0 mode, the wireless transceiver 1044 in the signal receiving apparatus 104 first receives the wireless signals in a shorter distance or the wireless signals having high power. Then, the algorithm controller 1046 generates the quality parameter Sd based on the detection of the quality of the wireless signal Srf, and then refers to the quality parameter Sd to determine whether the quality of the wireless signal Srf is lower than a quality threshold. If the quality of the wireless signal Srf is lower than the quality threshold, it means that the operation clock of the connecting device 106 has interfered with the signal reception of the wireless signal Srf that is performed by the signal receiving apparatus 104. At this moment, the algorithm controller 1046 controls the signal receiving apparatus 104 to enter the third signal receiving mode from the second signal receiving mode (step 314). That is, the wireless transceiver 1044 included in the signal receiving apparatus 104 would be turned off to stop receiving the wireless signal Srf. On the contrary, if the quality of the wireless signal Srf is not lower than the quality threshold, it means that the operation clock of the connecting device 106 does not interfere with signal reception of the wireless signal Srf that is performed by the signal receiving apparatus 104. At this moment, the algorithm controller 1046 controls the signal receiving apparatus 104 to continue receiving the wireless signal Srf with the second signal receiving mode (step 316).

In step 318, when the connecting device 106 is in the U1/U2 mode, it means that the connecting device 106 is in a low power consumption mode. Hence, the connecting device 106 does not generate signal radiation and signal coupling to interfere with signal reception of the wireless signal Srf that is performed by the signal receiving apparatus 104. At this moment, the algorithm controller 1046 controls the signal receiving apparatus 104 to receive the wireless signal Srf with the first signal receiving mode. That is, the wireless transceiver 1044 in the signal receiving apparatus 104 can receive the wireless signal Srf in a longest distance. Please notice that, in step 308, the algorithm, controller 1046 may directly turns off the wireless transceiver 1044 in the signal receiving apparatus 104 (the third signal receiving mode), thus skipping the step of determining the quality of the wireless signal Srf.

As can be known from the aforementioned paragraphs directed to the first control method 200 and the second control method 300, the operation modes of the signal receiving apparatus 104 can be categorized as the first signal receiving mode for receiving the wireless signal Srf in a longer distance, the second signal receiving mode for receiving the wireless signal Srf in a shorter distance, and the third signal receiving mode for stopping receiving the wireless signal Srf. The operation modes of the connecting device 106 can be categorized as the normal power consumption mode (the U0 mode) and the low power consumption mode (U1/U2 mode). Hence, to prevent the operation clock of the connecting device 106 from influencing the signal reception capability of the signal receiving apparatus 104 for the wireless signal Srf, the operation modes of the signal receiving apparatus 104 and the connecting device 106 have the following four combinations: (1) when the operation mode of the signal receiving apparatus 104 is an operation mode for receiving the wireless signal Srf in a longer distance, the operation mode of the connecting device 106 will be a low power consumption mode (corresponding to step 208 in FIG. 2 and step 318 in FIG. 3); (2) when the operation mode of the signal receiving apparatus 104 is an operation mode for receiving the wireless signal Srf in a shorter distance, the operation mode of the connecting device 106 will be a normal power consumption mode (corresponding to step 218 in FIG. 2 and step 316 in FIG. 3); (3) when the operation mode of the signal receiving apparatus 104 is an operation mode for receiving the wireless signal Srf in a shorter distance, the operation mode of the connecting device 106 will be a low power consumption mode (corresponding to step 218 in FIG. 2 and step 316 in FIGS. 3); and (4) when the operation mode of the signal receiving apparatus 104 is an operation mode for stopping receiving the wireless signal Srf, the operation mode of the connecting device 106 will be a normal power consumption mode (corresponding to step 314 in FIG. 3. Hence, based on the actual needs, a user can selectively control the time periods in which operation modes of the signal receiving apparatus 104 and the connecting device 106 stay, to thereby meet requirements of transmission characteristics and signal qualities of various applications.

For example, when the signal receiving apparatus 100 is used to perform an access point scan (AP scan) procedure (e.g., the 802.11 2.4 G scan procedure), the signal receiving apparatus 104 is operative to scan nearby signals to receive a wireless signal Srf from at least one base station. If the operation mode of the connecting device 106 is the normal power consumption mode (i.e., the U0 mode), the signal receiving apparatus 104 is interfered with the operation clock of the connecting device 106 to have poor quality of receiving the wireless signal Srf. Thus, in the present embodiment, when the signal receiving apparatus 100 is used to perform a scan procedure of the base station, the host 102 or the algorithm controller 1046 adjusts the connecting device 106 to enter the second operation mode (i.e., U1/U2 mode) from the first operation mode (i.e., U0 mode), directly sets the operation mode of the connecting device 106 to be the second operation mode, or refers to the quality of the wireless signal Srf to selectively control the connecting device 106 to enter the second operation mode from the first operation mode. Please notice that, when the connecting device 106 is operated in the second operation mode, there is no data transmission between the signal receiving apparatus 104 and the host 102. Meanwhile, the data of the nearby base stations that is received by the signal receiving apparatus 104 will be temporarily stored into the memory device 1048 of the signal receiving apparatus 104. After the signal receiving apparatus 104 collects all data of the nearby base stations, the signal receiving apparatus 104 suspends receiving the wireless signal Srf. Thus, the signal receiving apparatus 104 enters the first operation mode (i.e., U0 mode), and delivers the information related to nearby base stations that is stored in the memory device 1048 to the host 102 for information analysis. In this way, the operation clock of the connecting device 106 does not interfere with the scan procedure performed by the signal receiving apparatus 104 to scan information of the nearby base stations.

In summary, the signal receiving apparatus 100 of the present invention can utilize the aforementioned first control method and/or second control method to selectively control respective operation modes of the signal receiving apparatus 104 and the connecting device 106. In this way, the operation clock of the connecting device 106 does not generate signal radiation and signal coupling to interfere with the signal reception operation of the wireless signal Srf that is performed by the signal receiving apparatus 104, thus improving the signal receiving capability of the signal receiving apparatus 104.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a host;
a signal receiving apparatus, receiving a wireless signal; and
a connecting device, coupled between the host and the signal receiving apparatus, transmitting a transmission signal between the host and the signal receiving apparatus;
wherein the signal receiving apparatus controls the connecting device to selectively enter a second operation mode from a first operation mode according to a state of the signal receiving apparatus when it receives the wireless signal, so as to reduce interference of the wireless signal.

2. The communication apparatus of claim 1, wherein the signal receiving apparatus determines whether to control the connecting device to enter the second operation mode from the first operation mode according to whether a quality of the wireless signal is lower than a quality threshold during the signal receiving apparatus is receiving the wireless signal.

3. The communication apparatus of claim 1, wherein the signal receiving apparatus directly controls the connecting device to enter the second operation mode from the first operation mode when the signal receiving apparatus is receiving the wireless signal.

4. The communication apparatus of claim 1, wherein a power of the transmission signal when the connecting device is operated in the second operation mode is lower than a power of the transmission signal when the connecting device is operated in the first operation mode.

5. The communication apparatus of claim 1, wherein when the connecting device is operated in the second operation mode, the connecting device stops transmitting the transmission signal between the host and the signal receiving apparatus.

6. The communication apparatus of claim 1, wherein the signal receiving apparatus receives the wireless signal in a first signal receiving mode or in a second signal receiving mode, and a power of the wireless signal received by the signal receiving apparatus in the first signal receiving mode is lower than a power of the wireless signal received by the signal receiving apparatus in the second signal receiving mode.

7. The communication apparatus of claim 6, wherein when the signal receiving apparatus is operated in the first signal receiving mode, the signal receiving apparatus transceives the wireless signal in a longest distance; and when the signal receiving apparatus is operated in the second signal receiving mode, the signal receiving apparatus transceives the wireless signals in a shorter distance or the wireless signal having higher power.

8. The communication apparatus of claim 1, wherein when the signal receiving apparatus is used to perform a base station scanning procedure to receive the wireless signal from at least one base station, the connecting device enters the second operation mode from the first operation mode.

9. The communication apparatus of claim 1, wherein the signal receiving apparatus comprises:
a connecting device controller, coupled to the connecting device;
a wireless transceiver, coupled to the connecting device controller and an antenna, receiving the wireless signal from the antenna;
an algorithm controller, coupled to the connecting device controller and the wireless transceiver; and
a memory device, storing data corresponding to the wireless signal;
wherein the algorithm controller is used to refers to the state of the wireless signal for selectively controlling the connecting device to enter the second operation mode from the first operation mode.

10. The communication apparatus of claim 9, wherein the algorithm controller further determines that the signal receiving apparatus should receive the wireless signal in a first signal receiving mode or a second signal receiving mode, and a power of the wireless signal received by the signal receiving apparatus in the first signal receiving mode is lower than a power of the wireless signal received by the signal receiving apparatus in the second signal receiving mode.

11. The communication apparatus of claim 1, wherein the connecting device is a transmission line complying with a universal serial bus 3.0 (USB3.0) specification.

12. The communication apparatus of claim 1, wherein a carrier frequency of the wireless signal is substantially 2.4 GHz.

13. The communication apparatus of claim 1, wherein the first operation mode is a normal power transmission mode defined by a universal serial bus 3.0 (USB3.0) specification, and the second operation mode is a lower power transmission mode defined by the USB3.0 specification.

14. A signal receiving apparatus, capable of performing data transmission with a host through a connecting device, the signal receiving apparatus comprising:
a connection controller, coupled to the connecting device;
a wireless transceiver, coupled to the connecting device controller and an antenna, receiving the wireless signal from the antenna; and
a memory device, storing data corresponding to the wireless signal;
wherein the signal receiving apparatus controls the connecting device to selectively enter a second operation mode from a first operation mode according to a transmission state of the wireless signal.

15. The signal receiving apparatus of claim 14, further comprising:
an algorithm controller, coupled to the wireless transceiver and the connecting device controller, wherein the algorithm controller is implemented with hardware or firmware built in the signal receiving apparatus, for determining an operation mode of the connecting device according to the state of the wireless signal.

16. The signal receiving apparatus of claim 15, wherein the algorithm controller further determines that the signal receiving apparatus should receive the wireless signal in a first signal receiving mode or a second signal receiving mode, and a power of the wireless signal received by the signal receiving apparatus in the first signal receiving mode is lower than a power of the wireless signal received by the signal receiving apparatus in the second signal receiving mode.

17. The signal receiving apparatus of claim 16, wherein the connecting device is a transmission line complying with a universal serial bus 3.0 (USB3.0) specification.

18. The signal receiving apparatus of claim 15, wherein the algorithm controller determines whether to control the connecting device to enter the second operation mode from the first operation mode according to whether a quality of the wireless signal is lower than a quality threshold.

19. The signal receiving apparatus of claim 15, wherein when the signal receiving apparatus is receiving the wireless signal, the algorithm directly adjusts the connecting device to enter the second operation mode from the first operation mode.

20. The signal receiving apparatus of claim 15, wherein a power of a transmission signal when the connecting device is operated in the first operation mode is lower than a power of the transmission signal when the connecting device is operated in the second operation mode.

21. The signal receiving apparatus of claim 15, wherein when the connecting device is operated in the second operation mode, the connecting device stops transmitting a transmission signal between the host and the signal receiving apparatus.

22. The signal receiving apparatus of claim 15, wherein when the signal receiving apparatus is used to perform a base station scanning procedure to receive the wireless signal from at least one base station, the connecting device enters the second operation mode from the first operation mode.
